(19) United States
(12) Patent Application Publication
(10) Pub. No.: US 2004/0145709 A1
(43) Pub. Date: Jul. 29, 2004

(54) Systems and methods for full hemispherical projection using multiple projectors that generate multiple arrays of image pixels that overlap along a single edge

(76) Inventors: D?apos;nardo Colucci, Minneapolis, MN (US); Suresh Balu, Chapel Hill, NC (US); Raymond L. Idaszak, Apex, NC (US); Tim Fletcher, Raleigh, NC (US)

Correspondence Address: MYERS BIGEL SIBLEY & SAJOVEC, PO BOX 37428, RALEIGH, NC, 27627, US

(21) Appl. No.: 10/665,162

(22) Filed: Sep. 17, 2003

Related U.S. Application Data
(60) Provisional application No. 60/411,910, filed on Sep. 19, 2002.

(51) Int. Cl. G03B 21/26

(52) U.S. Cl. 353/94

(57) ABSTRACT

An optical projection system includes a first image source that is configured to generate a first array of image pixels and a first lens assembly that is configured to project the first array of image pixels onto a non-planar surface. A second image source is configured to generate a second array of image pixels and a second lens assembly is configured to project the second array of image pixels onto the non-planar surface. The first and second arrays of image pixels overlap along a single edge and the combination of the first and second arrays of image pixels covers a continuous portion of the surface.

### RELATED APPLICATION

This application claims the benefit of and priority to U.S. Provisional Patent Application No. 60/411,910, filed Sep. 19, 2002, the disclosure of which is hereby incorporated herein by reference as if set forth in its entirety.

### BACKGROUND OF THE INVENTION

The present invention relates to optical projection systems and methods, and, more particularly, to hemispherical optical projection systems and methods.

Immersive virtual environments have many applications in such fields as simulation, visualization, and space design. A goal of many of these systems is to provide the viewer with a full sphere (180°×360°) of image or a hemispherical image (90°×360°). In achieving this goal, there is traditionally a trade-off between complexity and cost. Fully immersive systems using rear projection typically use multiple projectors placed around the display surface. These systems, however, may require significant alignment and upkeep, including edge blending and color matching. They also may be expensive and may require a room that is on average twice as big as the display surface. Multi-projector front projection environments typically do not require the extra room of rear projection environments, but may not achieve the same level of immersion and still may suffer the same cost and alignment problems. Single projector, front projection environments may be lower cost and may also be more readily aligned, but these systems may not provide the user with greater than a 170° field of view (FOV) because the viewer may need to be located behind the projector. For example, as shown in FIG. 1, a viewer that is located behind a projector with an angle of projection of approximately 170° achieves an effective FOV of approximately 125°.

### SUMMARY OF THE INVENTION

According to some embodiments of the present invention, an optical projection system comprises a first image source that is configured to generate a first array of image pixels and a first lens assembly that is configured to project the first array of image pixels onto a non-planar surface. A second image source is configured to generate a second array of image pixels and a second lens assembly is configured to project the second array of image pixels onto the non-planar surface. The first and second arrays of image pixels overlap along a single edge and the combination of the first and second arrays of image pixels covers a continuous portion of the surface. In some embodiments, the combination of the first and second array of image pixels may cover a continuous, 180 degree portion of the non-planar surface to provide full hemispherical projection. By using separate image sources and lens assemblies to respectively provide truncated or partial hemispherical projections that when combined provides full hemispherical projection, brightness may be improved over optical projection systems that use a single image source/lens assembly combination to provide full hemispherical projection. Moreover, embodiments using truncated or partial hemispherical projection may take advantage of the 4:3 aspect ratio of conventional digital projectors, which may result in improved image resolution.

The lens assemblies may be further configured to project the respective arrays of image pixels onto the surface such that there is a constant angular separation between adjacent projected pixels. Moreover, the lens assemblies may project the arrays of image pixels onto surfaces, such as hemispherical surfaces, of varying radii.

In various embodiments of the present invention, the image sources may respectively comprise a cathode ray tube, a field emitter array, and/or any other two-dimensional image array. The image sources may also respectively comprise a digital light processing (DLP) unit, a liquid crystal display (LCD) unit, and/or a liquid crystal on silicon (LCOS) unit.

In further embodiments of the present invention, the optical projection system may comprise a dome that has an inner surface. The lens assemblies may be configured to project the arrays of image pixels onto the inner surface of the dome such that the first and second arrays of image pixels overlap along a single edge and the combination of the first and second arrays of image pixels covers a continuous, 180 degree portion of the inner surface.

In still further embodiments of the present invention, the first lens assembly and the second lens assembly are positioned apart from each other such that a brightness of the first and second arrays of image pixels where the first and second arrays of image pixels overlap along the single edge on the surface is approximately equal to a brightness of the first and second arrays of image pixels where the first and second arrays of image pixels do not overlap on the surface.

Although described primarily above with respect to system and/or apparatus embodiments of the present invention, it should be understood that the present invention may be embodied as methods of optical projection.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a diagram that illustrates a conventional optical projection system that projects an array of image pixels at an angle of projection less than 180°;

FIGS. 2A and 2B are block diagrams that illustrate optical projection systems and methods for projecting an array of image pixels at an angle of projection greater than 180° in accordance with some embodiments of the present invention;

FIG. 3 is a schematic diagram that illustrates embodiments of an image source and lens assembly that may be used in optical projection systems and methods for projecting an array of image pixels at an angle of projection greater than 180° in accordance with some embodiments of the present invention;

FIG. 4 is a diagram that illustrates an optical projection system, according to some embodiments of the present invention, projecting an array of image pixels at an angle of projection of 240° to provide a viewer with a full hemispherical field of view;

FIG. 5 is a diagram that illustrates an active area of an optical projection system lens assembly, according to some embodiments of the present invention, that is used to provide a fill hemispherical field of view;

FIG. 6 is a diagram that illustrates an active area of an optical projection system lens assembly, according to some embodiments of the present invention, that is used to fill a truncated hemisphere; and

FIG. 7 is a diagram that illustrates an optical projection system, according to some embodiments of the present invention, incorporating dual image sources and lens assemblies projecting arrays of image pixels so as to each fill a portion of a hemisphere in a dome and blended along a single line to provide a viewer with a full hemispherical field of view.

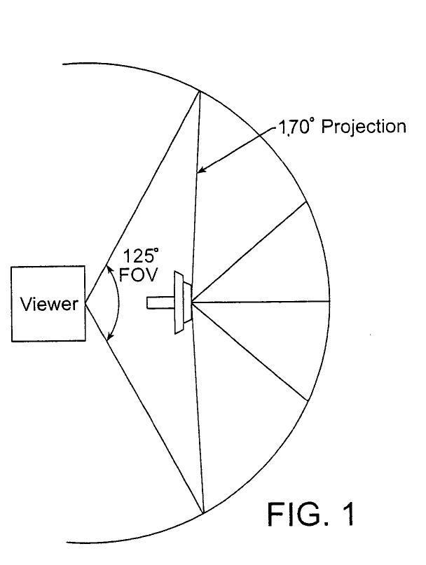

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

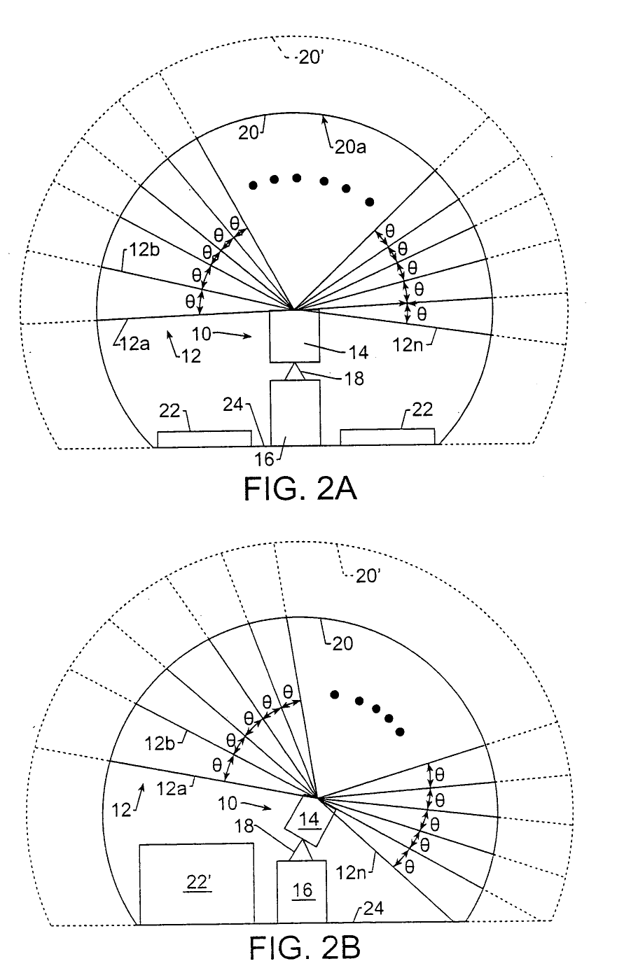

Referring now to FIGS. 2A and 2B, a tiltable optical projection system having constant angular separation of projected pixels, according to some embodiments of the present invention, will now be described. An optical projection system 10 projects an array of image pixels 12 having constant angular separation among adjacent pixels as indicated by the angle θ, which is constant among adjacent pixels 12a-12n. The constant angular separation among adjacent pixels may be provided as described, for example, in U.S. Pat. No. 5,762,413 (hereinafter “'413 patent”), entitled “Tiltable Hemispherical Optical Projection Systems and Methods Having Constant Angular Separation of Projected Pixels” and assigned to the assignee of the present application, the disclosure of which is hereby incorporated herein by reference. Moreover, the optical projection system 10 is configured to project the array of image pixels 12 at a projection angle greater than 180°. As shown in FIGS. 2A and 2B, the optical projection system 10 projects the array of image pixels 12 having constant angular separation onto the inner surface 20a of a truncated hemispherical dome 20. The greater than 180° optical projection system 10 may be referred to as an F-θ inverse telephoto lens, where f is the focal length of the lens and θ is the angle of projection. Although embodiments of the present invention are illustrated herein in the context of projecting image pixels onto a hemispherical surface, it will be understood that any screen surface may be used, including, but not limited to, hyper-hemispherical surfaces and elliptical surfaces.

By maintaining constant angular separation among adjacent pixels, a low distortion image may be projected by the optical projection system 10 onto domes of varying radii, which is illustrated by surface 20′. Domes of radii from 4 to 8 meters may be accommodated in accordance with some embodiments of the present invention. To maintain low distortion with constant angle of separation, the optical projection system 10 may be mounted at the center of the inner dome surface 20a so as to radially project the array of image pixels 12 onto the inner dome surface.

Still referring to FIGS. 2A and 2B, some embodiments of the optical projection system 10 also comprise means for tilting or aiming the array of image pixels 12 so that the optical projection system 10 projects the array of pixels onto a plurality of selectable positions on the inner dome surface 20a. For example, as shown in FIGS. 2A and 2B, the projecting optics 14 may be pivotally mounted on a base 16 using a pivot 18. The base 16 is located on the floor 24 of the dome 20. The pivot 18 may allow pivoting within a plane or in multiple planes. The design of the pivot 18 is generally known to those skilled in the art and need not be described further herein.

By incorporating tilting or aiming means, the optical projection system 10 may project vertically upward in a planetarium projection as shown in FIG. 2A or may project at an angle (for example 45 degrees) from vertical in a theater projection position, as shown in FIG. 2B. Typically, when projecting in a planetarium style as shown in FIG. 2A, the audience area 22 surrounds the projection system 10. In contrast, when projecting theater style, the audience area 22′ is typically behind the optical projection system 10 and the audience area 22′ is raised so that the audience can see the entire field of view in front of them. Thus, different audience configurations may be accommodated.

The dome 20 may be constructed for portability and ease of assembly and disassembly. Exemplary embodiments of the dome 20 are described in U.S. Pat. No. 5,724,775, entitled “Multi-Pieced, Portable Projection Dome and Method of Assembling the Same” and assigned to the assignee of the present application, the disclosure of which is hereby incorporated herein by reference.

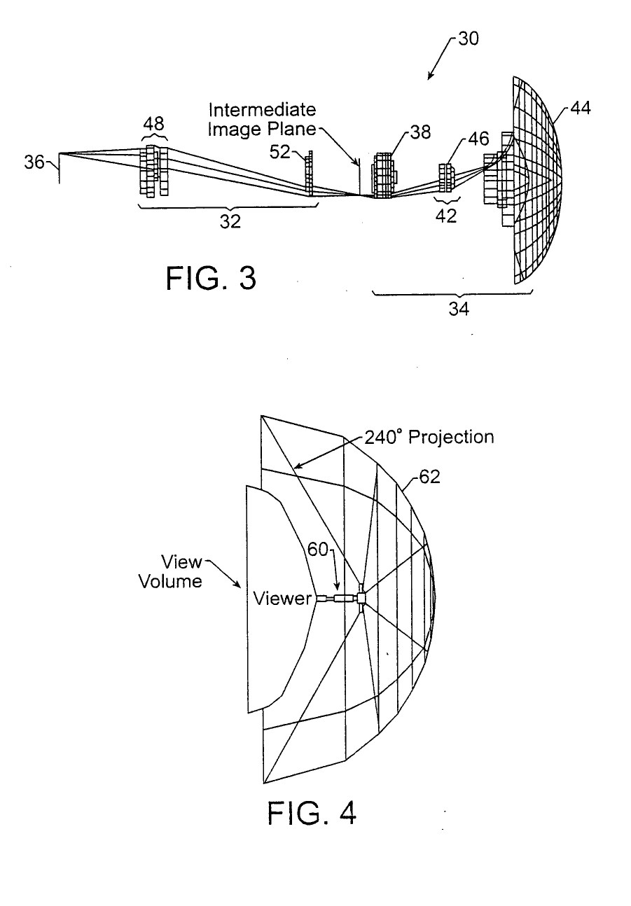

Referring now to FIG. 3, a lens assembly 30 that may be used in the optical projection system 10 to project an array of image pixels at a projection angle greater than 180°, in accordance with some embodiments of the present invention, will now be described. The lens assembly 30 comprises an image relay lens assembly 32 and a wide-angle lens assembly 34 that are positioned in a path of an array of image pixels. The lens assembly 30 is configured such that the array of image pixels may be projected at a projection angle greater than 180°. The array of image pixels is generated by an image source 36. In accordance with various embodiments of the present invention, the image source 36 may be a cathode ray tube, a field emitter array, or any other two-dimensional image array. The image source may also comprise a digital light processing (DLP) unit, a liquid crystal display (LCD) unit, and/or a liquid crystal on silicon (LCOS) unit. The array of image pixels may be formed by a single light path for projecting gray scale images, a single light path for projecting color images, or by combining separate red, green, and blue light paths as described in the above incorporated '413 patent.

In some embodiments, the wide-angle lens assembly 34 comprises a lens assembly 38, a wavefront shaping lens assembly 42, and a meniscus lens assembly 44. The wavefront shaping lens assembly 42 may comprise a diffractive optical element 46 that may allow for color correction and/or higher order wavefront shaping based on the field of view to be provided. Exemplary embodiments of the wavefront shaping lens assembly 42, and the meniscus lens assembly 44 are described in detail in the '413 patent.

Conventional inverse telephoto projection systems may exhibit the general characteristic that the back focal distance, (i.e., the farthest distance between a lens in the lens assembly and the image source) is longer than the effective focal length (i.e., the focal length of a theoretical single element lens having the same optical characteristics as the lens assembly) because of space occupied by optical and mechanical components. Advantageously, in accordance with some embodiments of the present invention, the image relay lens assembly 32, comprising lenses 48 and 52, may optically relay the array of image pixels between the image source 36 and the wide-angle lens assembly 34. The dispersion in the array of image pixels at an intermediate image plane near the wide angle lens assembly 34 is similar to the dispersion in the array of image pixels near the image source 36. Advantageously, this may allow the conflict between back focal distance and effective focal length to be reduced.

Referring now to FIG. 4, an optical projection system 60, in accordance with some embodiments of the present invention, is illustrated as projecting an array of image pixels onto an inner surface of a hemispherical dome structure 62 at a projection angle greater than 180°. The optical projection system 60 may be implemented as discussed above with respect to FIGS. 2 and 3. As shown in FIG. 4, the optical projection system 60 projects the array of image pixels at a projection angle of approximately 240°. Advantageously, this may allow a viewer located behind the optical projection system 60 to achieve a full hemispherical field of view, i.e., at least a 180° field of view.

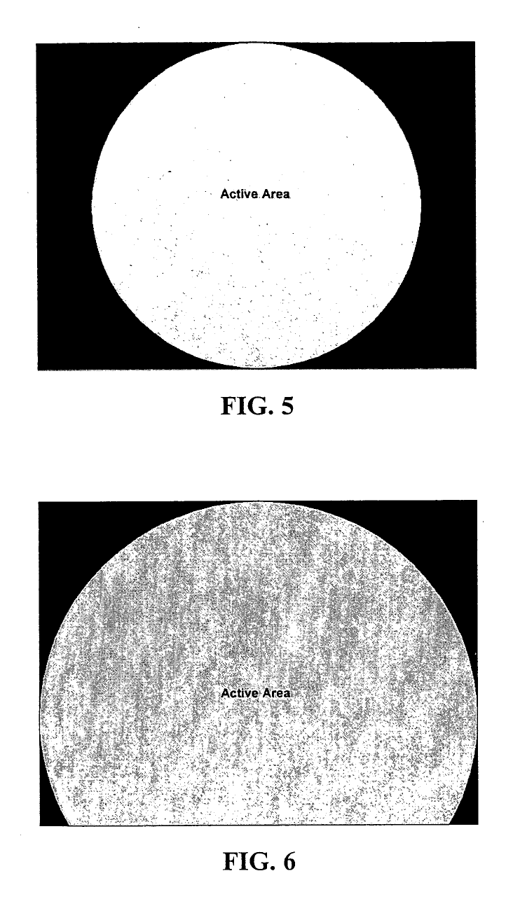

When a single optical projection system, such as, for example, the optical projection system 30 of FIG. 3, is used to provide a full hemispherical field of view, the active area, (i.e., the image projected onto a surface) of the optical projection system may fill approximately 59% of the lens as shown in FIG. 5. When an optical projection system, such as, for example, the optical projection system 30 of FIG. 3, is used to fill a truncated hemisphere, i.e., less than a 180° field of view, however, the active area of the optical projection system may fill approximately 83% of the lens as shown in FIG. 6. Advantageously, embodiments using truncated or partial hemispherical projection may take advantage of the 4:3 aspect ratio of conventional digital projectors, which may result in a 33.3% increase in resolution (4/3=1.333). Truncated or partial hemispherical projection embodiments may also provide increased brightness due to the increase in active area over full hemispherical projection embodiments.

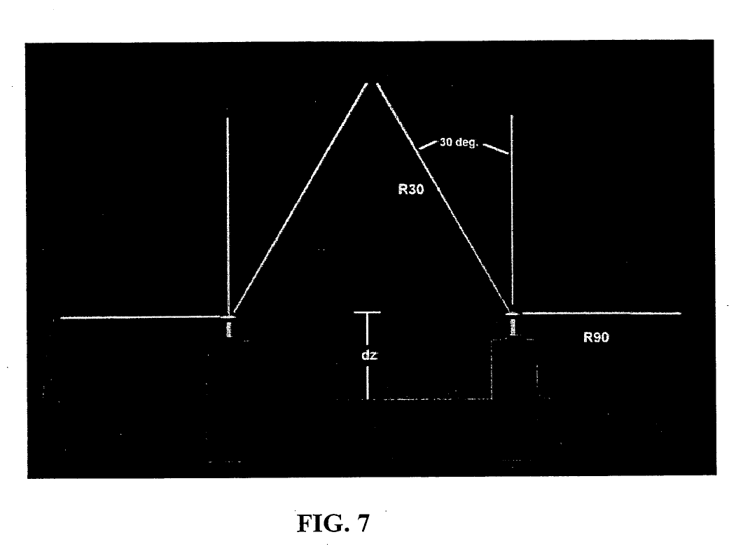

In other embodiments of the present invention illustrated in FIG. 7, two optical projection systems 70 and 72, each of which may be implemented as discussed above with respect to FIGS. 2 and 3, are configured to project first and second arrays of image pixels onto the inner surface of a hemispherical dome structure 74 at respective projection angles less than 180°, i.e., a truncated or partial hemispherical projection. The combination of the first and second arrays of image pixels projected by the optical projection systems 70 and 72 covers a continuous, 180° portion of the hemispherical inner surface of the dome structure 74. Each projection system 70, 72 illuminates approximately half of the hemisphere and there is image overlap along the central meridian 76 of the dome structure 74. Conventional edge blending methods may be used in the image overlap region. The images projected by optical projection systems 70 and 72, however, need be blended only along a single edge. Advantageously, a full hemispherical image may be provided using the two optical projection systems 70 and 72 that has approximately 2.8 times the brightness and approximately 33.3% greater resolution than a single projector, full hemispherical projection design.

The placement of the projection systems 70 and 72 within the hemispherical dome structure 74 may be selected to allow the brightness of the image to be generally uniform along the inner surface of the hemispherical dome structure 74. As shown in FIG. 7, based on the angle of projection used by the optical projection systems 70 and 72, the separation between the optical projection systems 70 and 72 is set at a constant 30° from the center meridian to ensure adequate overlap along the central meridian. The brightness of the image falls off as (1/distance to the surface)². The distance from each optical projection system 70, 72 to the central meridian is denoted by R30, to the event horizon is denoted by R90, and into the dome structure 74 is denoted by dz. Table 1 sets forth these various distances (normalized to the dome structure 74 radius) as the optical projection systems 70 and 72 are moved into the dome structure 74.

TABLE 1

| | | | | Projector |
|---|---|---|---|---|
| dz | R30 | R90 | Ratio | Separation |
| 0.000 | 1.155 | 0.423 | 0.366 | 1.155 |
| 0.050 | 1.097 | 0.450 | 0.410 | 1.097 |
| 0.100 | 1.039 | 0.475 | 0.457 | 1.039 |
| 0.150 | 0.982 | 0.498 | 0.507 | 0.982 |
| 0.200 | 0.924 | 0.518 | 0.561 | 0.924 |
| 0.250 | 0.866 | 0.535 | 0.618 | 0.866 |
| 0.300 | 0.808 | 0.550 | 0.680 | 0.808 |
| 0.350 | 0.751 | 0.561 | 0.748 | 0.751 |
| 0.400 | 0.693 | 0.570 | 0.823 | 0.693 |
| 0.450 | 0.635 | 0.575 | 0.906 | 0.635 |
| 0.500 | 0.577 | 0.577 | 1.000 | 0.577 |

Based on the entries in Table 1, a distance dz of about 0.32 times the dome structure 74 radius and a ratio of R90 to R30 of about 0.707 may provide approximately equal brightness across the dome structure 74 inner surface. In this case, the relative brightness at the central meridian is about 2*(1/0.785)²=3.24 and the relative brightness at the event horizon is about (1/0.555)²=3.24

It should be further understood that in other embodiments of the present invention, the optical projection systems 70 and 72 of FIG. 7 may be embodied by optical projection systems that individually are not capable of providing full hemispherical projection (i.e., at least a 180° field of view).

Many variations and modifications can be made to the preferred embodiments without substantially departing from the principles of the present invention. All such variations and modifications are intended to be included herein within the scope of the present invention, as set forth in the following claims. It will be understood that the scope of the present invention is not limited by the claims, but is intended to encompass the present disclosure, including structural and functional equivalents thereof.

We claim:

1. An optical projection system, comprising:
a first image source that is configured to generate a first array of image pixels;
a first lens assembly that is configured to project the first array of image pixels onto a non-planar surface;
a second image source that is configured to generate a second array of image pixels; and
a second lens assembly that is configured to project the second array of image pixels onto the non-planar surface such that the first array of image pixels and the second array of image pixels overlap along a single edge and a combination of the first array of image pixels and the second array of image pixels covers a continuous portion of the non-planar surface.

2. The optical projection system of claim 1, wherein the first and second lens assemblies are configured to respectively project the first and second arrays of image pixels onto the surface such that there is a constant angular separation between adjacent pixels.

3. The optical projection system of claim 1, wherein the non-planar surface is a hemispherical surface.

4. The optical projection system of claim 3, wherein the first and second lens assemblies are configured to respectively project the first and second arrays of image pixels onto hemispherical surfaces of varying radii.

5. The optical projection system of claim 1, wherein the first and second image sources comprise first and second cathode ray tubes, respectively.

6. The optical projection system of claim 1, wherein the first and second image sources comprise first and second field emitter arrays, respectively.

7. The optical projection system of claim 1, wherein the first and second image sources comprise respective units selected from the group of units consisting of a digital light processing unit, a liquid crystal display unit, and a liquid crystal on silicon unit.

8. The optical projection system of claim 1, further comprising:
a dome that comprises an inner surface; and
wherein the first and second lens assemblies are configured to respectively project the first and second arrays of image pixels onto the inner surface of the dome such that the first array of image pixels and the second array of image pixels overlap along the single edge and the combination of the first array of image pixels and the second array of image pixels covers a continuous, 180 degree portion of the inner surface.

9. The optical projection system of claim 1, wherein the first lens assembly and the second lens assembly are positioned apart from each other such that a brightness of the first and second arrays of image pixels where the first and second arrays of image pixels overlap along the single edge on the surface is approximately equal to a brightness of the first and second arrays of image pixels where the first and second arrays of image pixels do not overlap on the surface.

10. The optical projection system of claim 1, wherein the combination of the first array of image pixels and the second array of image pixels covers a continuous, 180 degree portion of the surface.

11. A method of projecting an image, comprising:
projecting a first array of image pixels onto a non-planar surface; and
projecting a second array of image pixels onto the non-planar surface such that the first array of image pixels and the second array of image pixels overlap along a single edge and a combination of the first array of image pixels and the second array of image pixels covers a continuous portion of the non-planar surface.

12. The method of claim 11, wherein projecting the first array of image pixels comprises:
projecting the first array of image pixels onto the non-planar surface such that there is constant angular separation between adjacent pixels; and
projecting the second array of image pixels onto the non-planar surface such that there is constant angular separation between adjacent pixels.

13. The method of claim 11, wherein the surface is a hemispherical surface.

14. The method of claim 11, wherein projecting the first array of image pixels and projecting the second array of image pixels comprises:
projecting the first and second arrays of image pixels onto the surface such that a brightness of the first and second arrays of image pixels where the first and second arrays of image pixels overlap along the single edge on the surface is approximately equal to a brightness of the first and second arrays of image pixels where the first and second arrays of image pixels do not overlap on the surface.

15. The method of claim 11, wherein the combination of the first array of image pixels and the second array of image pixels covers a continuous, 180 degree portion of the non-planar surface.
